(19) United States
(12) Patent Application Publication
(10) Pub. No.: US 2014/0244533 A1
(43) Pub. Date: Aug. 28, 2014

(54) Connecting Individuals with Organizational Opportunities

(71) Applicant: Givsum, LLC, Aliso Viejo, CA (US)

(72) Inventors: Robert Lionel Kollar, Aliso Viejo, CA (US); Shawn Eric Wehan, Dana Point, CA (US); Dewey Scott Bushaw, Aliso Viejo, CA (US); Matthew Joseph Masoni, Laguna Niguel, CA (US); Alan Lawrence McCann, Laguna Niguel, CA (US); Robert Todd Winslow, Aliso Viejo, CA (US)

(73) Assignee: Givsum, LLC, Aliso Viejo, CA (US)

(21) Appl. No.: 14/187,304

(22) Filed: Feb. 23, 2014

Related U.S. Application Data
(60) Provisional application No. 61/768,489, filed on Feb. 24, 2013.

(51) Int. Cl. G06Q 10/10

(52) U.S. Cl. CPC G06Q 10/1053
USPC 705/321

(57) ABSTRACT

Individuals may be connected with organizations via a communications network. A resume database may hold resume data for one or more independent users. The resume data may include donated time, monetary contributions, and/or the like. An organization database may hold organization data for one or more independent organizations. The organizational data may include opportunities, events, and/or the like.

### CROSS-REFERENCE TO RELATED APPLICATIONS

This application claims the benefit of U.S. Provisional Application No. 61/768,489, filed Feb. 24, 2014, entitled “Connecting Individuals with Organizational Opportunities,” which is hereby incorporated by reference in its entirety.

### BRIEF DESCRIPTION OF THE SEVERAL VIEWS OF THE DRAWINGS

FIG. 1 is an example block diagram showing individuals connecting with organizations as per an aspect of an embodiment.

FIG. 2 is an example flow diagram of individuals connecting with organizations as per an aspect of an embodiment.

FIG. 3 is a block diagram of a computing environment in which aspects of embodiments of the present invention may be practiced.

### DETAILED DESCRIPTION OF EMBODIMENTS

Embodiments enable the connection between individuals and organizational opportunities.

One of the various embodiments may include a directory of philanthropic resumes. The directory may separate out users as chapters of organizations. Users may also be representatives of organizations. Alternatively, users may be independent and include individuals. User(s) may have a login and a modifiable profile. Users may be added to the directory following a membership sign-up procedure. Privacy settings may enable users to choose who may view their personal and/or business information.

According to some of the various embodiments, events and/or volunteer opportunities attended by a user may be logged on to a user's profile (including hours volunteered). This information may be made available for presentation. Logging may be performed by a computing device such as an application running on a mobile phone, a tablet, a computer, and/or the like. The computing device may be enabled to capture check-in time, check-out time, total time, and/or the like. Links may be created from past attended events that may include content such as photos, video(s) and information regarding the event. Some embodiments may have a capability to log money, services, or other items donated to various organizations for a personal record. Privacy settings may enable users to choose which aspect(s) of their personal record is shared, if any, and who may view the shared aspect(s). A user's profile may be shared, for example, with another user, a group of users, all users, an organization, a group of organizations, all organizations, any combination thereof, and/or the like. A user's profile may show all the organizations the user has worked with throughout the course of a period of time (e.g. a year, a giving season, and/or the like) via awareness events, volunteer opportunities, fund raisers, special events, and/or the like.

Over time, a directory profile may operate as a “philanthropic resume.” At the end of a period of time (e.g. a year), a user may be able to look back and see everything they did to make a difference in a community. The user may be able to share this information with their employers (matching dollars), at job interviews, with friends to inspire similar action, and/or the like.

To get started, a user may click on a link that matches the user with options such as: (1) enabling the user to create a new profile; (2) enable a current user that has a current profile to edit their profile; (3) import a user profile; and/or the like.

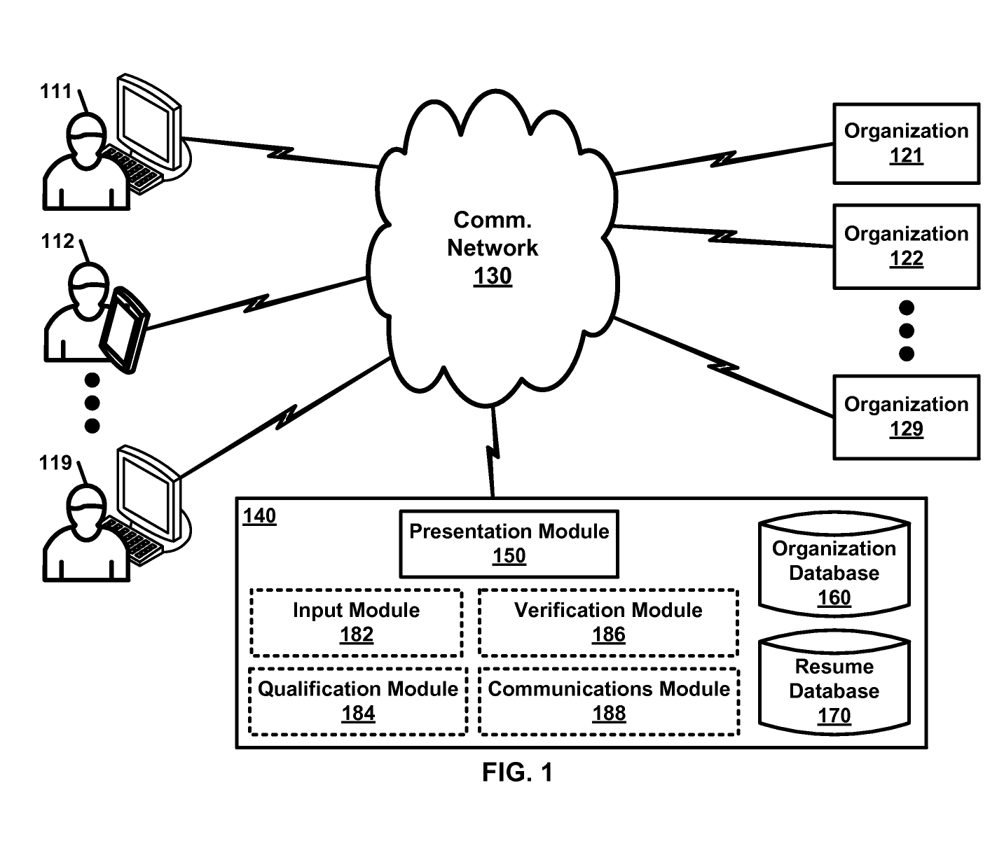

FIG. 1 is an example block diagram showing individuals (111, 112, . . . 119) connecting with organizations (121, 122, . . . 129) employing an apparatus 140 via a communications network 130 as per an aspect of an embodiment. According to some of the various embodiments, the apparatus may include a resume database 170, an organization database 160, and a presentation module 150.

The resume database 170 may be configured to hold resume data for one or more independent users (111, 112, . . . 119). The resume data may include donated time, monetary contributions, associated organizations, associated events, educational level, skill level, volunteer experience, industrial experience, and/or the like. According to some embodiments, a call to a Ruby on Rails find function for a user may cause data to be returned that includes, for example, “education level” and/or “industry experience.” In addition, the relationship for past opportunities may be called upon and the returned data passed to a volunteer experience function to calculate, for example, a “skill level” and may also be listed to show, for example, “volunteer experience.”

Some of the various embodiments may be employed using web application framework(s) such as Ruby on Rails. Ruby on Rails, often simply Rails, is an open source web application framework which runs via the Ruby programming language. Ruby may provide a full-stack framework: Ruby allows creating pages and applications that gather information from a web server, talk to or query database(s), and render templates. As a result, Rails may employ a routing system that is independent of the web server. Ruby on Rails emphasizes the use of software engineering patterns and principles, such as active record pattern, convention over configuration (CoC), don't repeat yourself (DRY), and model-view-controller (MVC).

The Ruby on Rails framework may be configured to map table(s) in a database, and a Ruby file. A controller component of Rails may respond to external requests from a web server to an application by determining which view file to render. The controller may also query one or more models directly for information and pass these on to the view. A controller may provide one or more actions. In Ruby on Rails, an action is typically a basic unit that describes how to respond to a specific external web-browser request. Also note that the controller/action may be accessible for external web requests if a corresponding route is mapped to it. RESTful routes may be employed that include actions such as: create, new, edit, update, destroy, show, and index. These mappings of incoming requests/routes to controller actions may be set up in the routes configuration file.

A view in some configurations of Rails may be an erb file, which may be converted to HTML at run-time. Other templating systems may also be employed for views. Scaffolding applications may be employed to automatically construct some of the models and views needed. Also, web servers such as WEBrick, Lighttpd, Apache, Cherokee, Hiawatha, and nginx may be employed with Ruby on Rails to provide a development environment. Ruby on Rails may be connected to the Internet directly or through a front-end web server. According to some of the various embodiments, some of the described functionality may also employ other tools such as JavaScript, Ajax, and SOAP. Output formats may include, but are not limited to HTML and XML formats. Additionally, CSS templating may be employed.

The resume data may be broken-up and stored in multiple tables inside an application database. The tables may include, for example: users, donations, contributions, tickets, and/or the like. The resume data may be stored, for example, by adding new rows of data into tables by using Ruby on Rails functionality to create the row and save it.

According to some of the various embodiments, the resume database 170 may be a philanthropic resume database. In some of these embodiments, an application database may have tables configured to, among other things, promote and track philanthropy. Examples of tables configured to promote and track philanthropy, include, but are not limited to: contributions, donations, opportunities, and/or the like. However, one skilled in the art will recognize that according to some of the various embodiments, the resume database may include resume information for other areas of interest to independent users.

Resume data may include links. According to some of the embodiments, resume data may be returned by making a call on the relationship for the user or organization. This data may then be used in conjunction with Ruby on Rails path functions to create links to the related parts of the application.

Some of the links may be created from past events. For example, according to some of the various embodiments, when the opportunities relationship is called upon with the scope of “past,” a lambda function may be used to set a where clause on an SQL query to return opportunities up to Time.zone.now. The returned opportunities may then be used in conjunction with Ruby on Rails path functions to link to past opportunities that are events.

The resume data may include items such as, but not limited to: photo(s), video(s), information regarding event(s), future commitments of a user, organizations associated with a user's activity, links to one or more of the above, and/or the like.

An entity function may find the entity and call the related relationships which may include, for example, opportunities, organizations, users, and tickets. The resume data may then be returned for display. A photo for a user, organization, or opportunity may be displayed by sending the ID to the avatar function which uses the ID to find the URL for the photo.

Resume data may be built for individual user(s) by one or more activities. For example, resume data may be populated with activity associated with one or more of the independent organizations (121, 122, . . . 129). For example, when a user logs a time contribution and/or monetary donation with an organization, the data may be stored using Ruby on Rails inside a contributions and/or donations table, respectively. The time contribution and/or monetary donation data may also be used in calculating an update to column(s) in a user table such as a “total_pending_contributions” column, a “total_donations” column, and/or the like. Resume data may be built by calculating the returned data for contributions and donations and/or by using the data to build viewable and/or interactive graphs and charts.

The activity may be presented by organization, by event, by date, and/or the like. The resume data may include mileage tracked using mechanisms such as, but not limited to: navigation system(s), mobile application(s), web interface(s), and/or the like. For example, when a user logs mileage driven with an organization, the data may be used in calculating an update to a column, such as a “total_mileage” column in a user table. The data may be auto-generated using a navigation system on the device running a mobile application, manually entered, and/or the like. The resume data may also include hours tracked using a mechanism such as, but not limited to: time tracking device(s), mobile application(s), web interface(s), and/or the like. For example, when a user logs a time contribution the data may be stored in a contributions table and used in calculating an update to a column, such as a “total_pending_contributions” column, in a user table. The data may be auto-generated using a timer on the device running the mobile application, manually entered, and/or the like.

Monetary contributions may be made using mechanisms such as mobile device(s), mobile application(s), web interface(s), web application(s), application programming interface(s), direct transfer(s), and/or the like. For example, when a user logs a monetary donation or makes one inside an application, the data may be stored in a table, such as a donations table, and used in calculating an update to a column in a user table, such as a “total_donations” column. This may be done via an application accessible to mobile devices, through an application on the device, through the device's web interface, and/or the like. According to some of the various embodiments, if a donation is made inside the application, a direct transfer of money from the user's account to the organization's account may be made.

Monetary contributions may be made using currency, digital currency, credit, a peer-to-peer payment system, one or more precious metals, one or more articles of value, and/or the like.

According to some of the various embodiments, resume data may be validated by at least some of the independent organization(s). For example, when a monetary donation or time contribution is logged via a log form, the monetary donation or time contribution may show up on the independent organizations' review page. An administrator or manager may verify the contribution/donation. The verification action may be logged on the contribution/donation inside a respective table in a database by updating a column such as a “state” and/or “approved_by_id” column.

According to some of the various embodiments, the organization database 160 may be a philanthropic organization database. The philanthropic organization database may comprise the combination of, for example, the contributions, donations, organizations, opportunities, and tickets tables in the application database. The organization database may hold organization data for one or more independent organizations (121, 122, . . . 129). The organizational data may include opportunities. At least some of the organization data may be populated with activity validated by one or more of the independent organizations (121, 122, . . . 129). For example, the specific organization's contributions, donations, opportunities, tickets may be tracked and stored in tables located inside the application database. When a manager or administrator verifies pending contributions/donations and/or the like on the organization's review page, the action may create approved contributions/donations and/or the like which may be shown in activity feeds that pull activity based on the approved state. At least some of the organization data may be populated with activity associated with one or more of the independent users (111, 112, . . . 119). One or more of the independent organizations (121, 122, . . . 129) may comprise a nonprofit organization, a committee, an ad hoc group, an established group, a business, a sponsor, an organization or business providing an internship, a combination thereof, and/or the like. The type of organization(s) may be labeled by setting a column, such as an “org_type” column, in the organizations table.

According to some of the various embodiments, the apparatus 140 may further include an input module 182 to accept one or more of user data and organizational data. For example, a log form may be employed to submit user and organizational data. The submitted data may include data to be processed and stored inside an application database(s). The data may include data such as, but not limited to, contribution data, donation data, mileage data, and/or the like.

The input module 182 may be further configured to accept user data only from a verified user. Forms, except the registration form, may require a user to be logged into the application with an active session in order to submit the data. According to some embodiments, Ruby on Rails current_user functionality may be used to determine if the logged in user is verified.

The input module 182 may be further configured to accept organizational data only from a verified organization. Forms pertaining to an organization may require a user to be logged into the application with an active session and with the role of at least manager for the organization in order to submit data. According to some of the various embodiments, Ruby on Rails current_user functionality may be used to determine if the logged in user is verified.

The input module 182 is further configured to operate over a network. For example, date submitted from a form may be initiated by the user's device and transmitted over a network to the one of many application servers utilizing standard transfer protocols.

The input module 182 may be further configured to operate over the web. For example, date submitted from a form may be initiated by a user's device and transmitted over the web to one of many application servers utilizing standard transfer protocols.

Organization data may be populated with activity associated with one or more of the independent users. For example, according to some of the various embodiments, when the activity of an action is displayed, the organization's name may be printed, an avatar function may be called to display the organization's logo, and a link may be generated using a Ruby on Rails path function in association with the independent user's name and action taken.

According to some of the various embodiments, the presentation module 150 may further present resume data to other independent users. So, for example, when independent users visit another independent user's profile, they may be shown resume data which is returned from an entity function which returns data that was retrieved by calling the Ruby on Rails relationship from specific models in the application.

The presentation module 150 may further present organizational data to users and other independent organizations. According to some embodiments, the profile of an organization may be shared, for example, with a user, a group of users, all users, another organization, a group of organizations, all organizations, any combination thereof, and/or the like. Users and/or designated members of an organization (e.g. manager and above), may visit the profile of another organization where they may be presented with organizational data via the entity function.

The presentation module 150 may be further configured to generate activity reports. The activity reports may be based on resume data, organizational data, donated time, monetary contributions, the completion of a role, a combination thereof, and/or the like. Activity reports may enable each organization to track goals and achievements, and assess the potential market for donations, volunteers, events, and/or the like. According to some embodiments, a profile page for a user or an organization may generate activity reports based on resume data and organizational data and may be displayed in either raw, chart, or graph form.

According to some of the various embodiments, the apparatus 140 may further include a qualification module 184. The qualification module 184 may be configured to match qualified independent users (111, 112, . . . 119) and independent organizations (121, 122, . . . 129). The matching may be based at least in part on at least part of the resume data and at least part of the organizational data. For example, utilizing contribution and/or donation history for a user and the user's personal information recorded in a user table, embodiments may attempt to match users with similar organizations based on organizational category types.

The qualification module 184 may be further configured to match qualified independent users (111, 112, . . . 119) and independent organizations (121, 122, . . . 129) autonomously. For example, embodiments may attempt to match users with similar organizations based on the results of searches performed by users. The matching may be performed automatically without employing metrics, user preferences, and/or the like.

The qualification module 184 may be further configured to match qualified independent users with philanthropic opportunities for independent organizations. For example, utilizing event/opportunity history for a user and the user's personal information recorded in a user table, embodiments may attempt to match users with similar organizations based on associated opportunity types and/or suggest related upcoming opportunities to the user.

The qualification module may be further configured to match qualified independent users and independent organizations autonomously employing a criteria. The criteria may include one or more of: an education level, a skill level, volunteer experience, industry experience, a combination thereof, and/or the like.

For example, utilizing a criteria for a user and the user's personal information recorded in a user table, embodiments may attempt to match users with similar organizations based on organizational needs.

According to some of the various embodiments, the apparatus 140 may further include a communication module 188. The communications module may facilitate communications among independent users (111, 112, . . . 119), among independent organizations (121, 122, . . . 129), and/or between independent users and independent organizations. For example, when a user signs up to volunteer for an opportunity, a manager of the opportunity or administrator of the organization may communicate to the user by sending them a notification via a notification form. The notification form may allow for a message type, subject line, and/or body message to be specified. A conversation id may be created and used for creating a threaded history for back and forth communication.

According to some of the various embodiments, the apparatus 140 may further include a verification module 186. The verification module 186 may be configured to verify reported user activity. For example, when a user checks-in or checks-out for an opportunity, a manager of the opportunity or administrator of the organization may be required to verify and approve the user activity via an approval form. The verification may be automatic, based on a criteria, or performed manually.

The user activity may include one or more of: donated time, monetary contributions, the completion of a role, a combination thereof, and/or the like. The activity item may be generated by an item helper which uses, for example, the Ruby on Rails find function to lookup the user and then use Ruby on Rails relationship functions to return the activity data along with the final state of the action which generated the activity.

According to some of the various embodiments, the apparatus may be part of a philanthropic social network. According to some of the various embodiments, actions may be taken either in an application or through an extension of the application. The application may create the philanthropic network by linking user devices, application servers, and/or database servers together to process and display data.

One or more of the independent organizations (121, 122, . . . 129) may provide one or more independent users with a reward based on an individual user activity level. When a user's contribution/donation is verified and approved, a reward function may be called where the data of a contribution/donation is used to determine a level of reward to be generated back to the user. This reward may be added to the total rewards the user currently has and recorded in the users table. Organizations providing a “reward” in exchange for hours, for example, may be able to deduct hours from an independent user's credit balance. The credit balance may be comprised of total hours, hours associated with one or more independent organizations, hours associated with one or more events, hours associated with one or more opportunities, and/or the like.

As described in some of the various embodiments, one or more of the independent organizations (121, 122, . . . 129) may approve volunteers. A manager or administrator of an organization may have the ability to approve/reject a volunteer on a per opportunity basis. When this happens, columns such as a “state” column and/or an “approved_by_id” column in a volunteers table may be updated to reflect the action taken. The approval may be manual or may be based on one or more of the following: an education level, a skill level, volunteer experience, industry experience, a combination thereof, and/or the like.

At least a part of the apparatus 140 may include one or more computing systems. One or more computing systems may comprise a server or other computing device. One or more of the computing systems may be a mobile device.

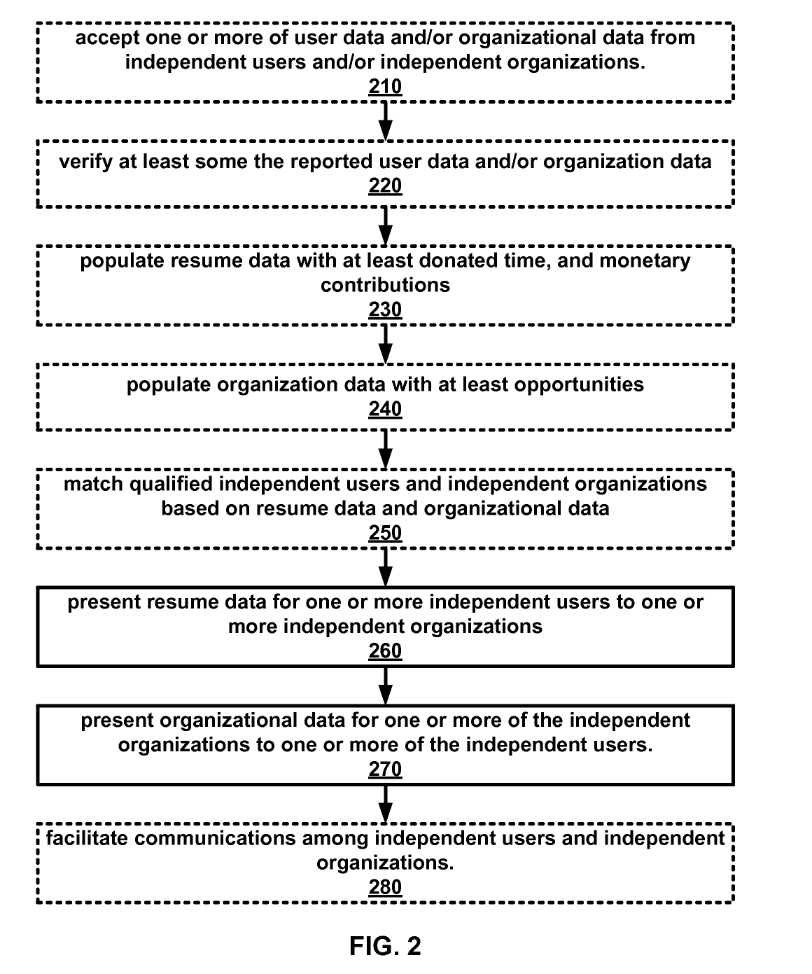

FIG. 2 is an example flow diagram of individuals connecting with organizations as per an aspect of an embodiment. Blocks illustrated with dashes represent options that may be used together or in various combinations with non-dashed blocks in various embodiments.

At block 210, one or more of user data and/or organizational data may be accepted from independent users and/or independent organizations. At least some the reported user data and/or organization data may be verified at block 220.

The resume data may be populated with at least donated time and monetary contributions at block 230. At block 240, organization data may be populated with opportunities and other data. At block 250, qualified independent users and independent organizations may be matched based on resume data and organizational data.

At least a portion of resume data for one or more independent users may be presented to one or more independent organizations at block 260. The resume data may include at least donated time and monetary contributions. According to some embodiments, when independent organizations access independent users' profiles, an entity function may look up the user via the Ruby on Rails find function and the user's ID. The user data returned may include the user's total donated time and monetary contributions. Additionally a list of specific donations and contributions may be returned by calling the relationship on the user such as @user.donations which may utilize the Ruby on Rails Framework relationship functions to find the related data.

Similarly, at least a portion of organizational data may be presented to one or more of the independent users at block 270. The organizational data may include, at least, opportunities. According to some of the various embodiments, when independent users access independent organizations' profiles, an entity function may look up the organization via the Ruby on Rails find function and the organization's ID. The organization data returned may include information such as the ID, name, organizational type, description, whether the organization accepts volunteers, and whether the organization tracks employee contributions. The opportunities for the organization may be returned by calling the opportunities relationship on the organization, for example @organization.opportunities, which may utilize the Ruby on Rails Framework relationship functions to find the related data.

Communications may be facilitated among independent users and independent organizations at block 280.

As described, in some of the various embodiments, an independent user or organization may interface with embodiments through a user interface. When an independent user or organization returns to an embodiment as described herein, the system may remember to pick up where the independent user or organization left off. According to some of the various embodiments, activities may be displayed by an organization(s) or event(s). Organizations may post events and may have the option to allow open events or invitation only events. Organizations may invite specific users to an event directly. Alternatively, users may be matched to events autonomously employing a criteria. Organizations may also post direct fundraisers. Organizations not contained in the “organization database” may receive invitations to join along with details on independent users looking to volunteer or donate. The details may be based on resume data and/or criteria that is associated with information provided by the organization. Each organization may be able to extract or import at least a portion of the data from the databases.

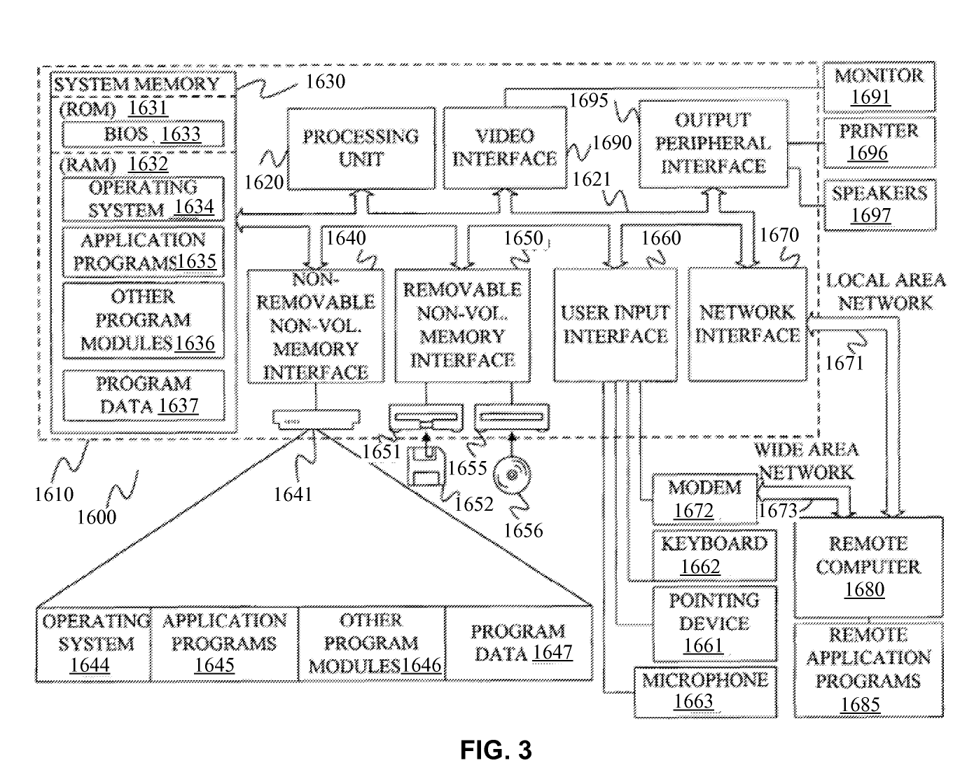

FIG. 3 illustrates an example of a suitable computing system environment 1600 on which embodiments may be implemented. The computing system environment 1600 is only one example of a suitable computing environment and is not intended to suggest any limitation as to the scope of use or functionality of the claimed subject matter. Neither should the computing environment 1600 be interpreted as having any dependency or requirement relating to any one or combination of components illustrated in the exemplary operating environment 1600.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 3, an example system for implementing some embodiments includes a general-purpose computing device in the form of a computer 1610. Components of computer 1610 may include, but are not limited to, a processing unit 1620, a system memory 1630, and a system bus 1621 that couples various system components including the system memory to the processing unit 1620.

Computer 1610 typically includes a variety of computer readable media. Computer readable media can be any available media that can be accessed by computer 1610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 1630 includes computer storage media in the form of volatile and/or nonvolatile memory such as read only memory (ROM) 1631 and random access memory (RAM) 1632. A basic input/output system 1633 (BIOS), containing the basic routines that help to transfer information between elements within computer 1610, such as during start-up, is typically stored in ROM 1631. RAM 1632 typically contains data and/or program modules that are immediately accessible to and/or presently being operated on by processing unit 1620. By way of example, and not limitation, FIG. 3 illustrates operating system 1634, application programs 1635, other program modules 1636, and program data 1637.

The computer 1610 may also include other removable/non-removable volatile/nonvolatile computer storage media. By way of example only, FIG. 3 illustrates a hard disk drive 1641 that reads from or writes to non-removable, nonvolatile magnetic media, a magnetic disk drive 1651 that reads from or writes to a removable, nonvolatile magnetic disk 1652, and an optical disk drive 1655 that reads from or writes to a removable, nonvolatile optical disk 1656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1641 is typically connected to the system bus 1621 through a non-removable memory interface such as interface 1640, and magnetic disk drive 1651 and optical disk drive 1655 are typically connected to the system bus 1621 by a removable memory interface, such as interface 1650.

The drives and their associated computer storage media discussed above and illustrated in FIG. 3, provide storage of computer readable instructions, data structures, program modules and other data for the computer 1610. In FIG. 3, for example, hard disk drive 1641 is illustrated as storing operating system 1644, application programs 1645, other program modules 1646, program data 1647, and or the like.

A user may enter commands and information into the computer 1610 through input devices such as a keyboard 1662, a microphone 1663, and a pointing device 1661, such as a mouse, trackball or touch pad. These and other input devices are often connected to the processing unit 1620 through a user input interface 1660 that is coupled to the system bus, but may be connected by other interface and bus structures, such as a parallel port, game port or a universal serial bus (USB). A monitor 1691 or other type of display device is also connected to the system bus 1621 via an interface, such as a video interface 1690.

The computer 1610 is operated in a networked environment using logical connections to one or more remote computers, such as a remote computer 1680. The remote computer 1680 may be a personal computer, a hand-held device, a smartphone, a server, a router, a network PC, a peer device or other common network node, and typically includes many or all of the elements described above relative to the computer 1610. The logical connections depicted in FIG. 3 include a local area network (LAN) 1671 and a wide area network (WAN) 1673, but may also include other networks. Such networking environments are commonplace in offices, enterprise-wide computer networks, intranets and the Internet.

When used in a LAN networking environment, the computer 1610 is connected to the LAN 1671 through a network interface or adapter 1670. When used in a WAN networking environment, the computer 1610 typically includes a modem 1672 or other means for establishing communications over the WAN 1673, such as the Internet. The modem 1672, which may be internal or external, may be connected to the system bus 1621 via the user input interface 1660, or other appropriate mechanism. In a networked environment, program modules depicted relative to the computer 1610, or portions thereof, may be stored in the remote memory storage device. By way of example, and not limitation, FIG. 3 illustrates remote application programs 1685 as residing on remote computer 1680. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e. hardware with a biological element) or a combination thereof, all of which are behaviorally equivalent. For example, modules may be implemented using computer hardware in combination with software routine(s) written in a computer language (Java, HTML, XML, PHP, Python, ActionScript, JavaScript, Ruby, Prolog, SQL, VBScript, Visual Basic, Perl, C, C++, Objective-C or the like). Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs), field programmable gate arrays (FPGAs), and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

Some embodiments may employ processing hardware. Processing hardware may include one or more processors, computer equipment, embedded system, machines and/or the like. The processing hardware may be configured to execute instructions. The instructions may be stored on a machine-readable medium. According to some embodiments, the machine-readable medium (e.g. automated data medium) may be a medium configured to store data in a machine-readable format that may be accessed by an automated sensing device. Examples of machine-readable media include: magnetic disks, cards, tapes, and drums, flash memory, memory cards, electrically erasable programmable read-only memory (EEPROM), solid state drives, optical disks, barcodes, magnetic ink characters, and/or the like.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, a philanthropic social network has been described as including a server and a mobile device. However, one skilled in the art will recognize that the server and mobile device may vary from a traditional server/device relationship over a network such as the internet. For example, a server may be collective based: portable equipment, broadcast equipment, virtual, application(s) distributed over a broad combination of computing sources, part of a cloud, and/or the like. Similarly, for example, a mobile device may be a user based client, portable equipment, broadcast equipment, virtual, application(s) distributed over a broad combination of computing sources, part of a cloud, and/or the like. Additionally, it should be noted that, for example purposes, several of the various embodiments were described as web based applications implemented at least in part using Ruby on Rails. However, one skilled in the art will recognize that many various languages and frameworks may be employed to build and use embodiments of the present invention. For example, languages/frameworks may be based upon Python, Django, Wordpress, and/or the like.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A non-transitory computer readable medium comprising computer readable instructions configured to cause a computing device to present, over a network to one or more computing devices, one or more of the following:
a) at least a portion of resume data for one or more independent users to one or more independent organizations, the resume data including donated time, and monetary contributions; and
b) at least a portion of organizational data for one or more of the independent organizations to one or more of the independent users, the organizational data including opportunities.

2. The medium according to claim 1, wherein the resume data includes links.

3. The medium according to claim 2, wherein the computer readable instructions are further configured to cause the computing device to create the links from past events.

4. The medium according to claim 1, wherein the resume data comprises one or more of:
a) a photo;
b) a video;
c) information regarding an event;
d) future commitments of a user;
e) organizations associated with a user activity; and
f) a link to one or more of the above.

5. The medium according to claim 1, wherein the computer readable instructions are further configured to cause the computing device to populate resume data with activity associated with one or more of the independent organizations.

6. The medium according to claim 1, wherein the computer readable instructions are further configured to cause the computing device to populate resume data with mileage tracked using one or more of:
a) a navigation system; and
b) a mobile application.

7. The medium according to claim 1, wherein the computer readable instructions are further configured to cause the computing device to populate resume data with hours tracked using one or more of:
a) a time tracking device; and
b) a mobile application.

8. The medium according to claim 1, wherein the resume data includes one or more of:
a) an education level;
b) a skill level;
c) volunteer experience; and
d) industry experience.

9. The medium according to claim 1, wherein the computer readable instructions are further configured to cause the computing device to build resume data for each individual user by one or more activities.

10. The medium according to claim 1, wherein the computer readable instructions are further configured to cause the computing device to populate at least some of the organization data with activity associated with one or more of the independent users.

11. The medium according to claim 1, wherein one or more of the independent organizations include one or more of:
a) a nonprofit organization;
b) a committee;
c) an ad hoc group;
d) an established group; and
e) a business.

12. The medium according to claim 1, wherein the computer readable instructions are further configured to cause the computing device to accept one or more of user data and organizational data.

13. The medium according to claim 1, wherein the computer readable instructions are further configured to cause the computing device to present resume data to other independent users.

14. The medium according to claim 1, wherein the computer readable instructions are further configured to cause the computing device to present organizational data to other independent organizations.

15. The medium according to claim 1, wherein the computer readable instructions are further configured to cause the computing device to generate activity reports based on resume data and organizational data.

16. The medium according to claim 1, wherein the computer readable instructions are further configured to cause the computing device to match qualified independent users and independent organizations based on resume data and organizational data.

17. The medium according to claim 1, wherein the computer readable instructions are further configured to cause the computing device to match qualified independent users and independent organizations autonomously.

18. The medium according to claim 1, wherein the computer readable instructions are further configured to cause the computing device to match qualified independent users with philanthropic opportunities for independent organizations.

19. The medium according to claim 1, wherein the computer readable instructions are further configured to cause the computing device to match qualified independent users and independent organizations autonomously employing a criteria, the criteria including one or more of:
a) an education level;
b) a skill level;
c) volunteer experience; and
d) industry experience.

20. The medium according to claim 1, wherein the computer readable instructions are further configured to cause the computing device to verify reported user activity.

21. The medium according to claim 20, wherein the user activity includes one or more of:
a) donated time;
b) monetary contributions; and
c) the completion of a role.

22. The medium according to claim 1, wherein the computer readable instructions are further configured to cause the computing device to present the data within a philanthropic network.

23. The medium according to claim 1, wherein the computer readable instructions are further configured to cause the computing device to enable one or more of the independent organizations to provide independent users with a reward based on an individual user activity level.
